(19) United States
(12) Patent Application Publication
(10) Pub. No.: US 2008/0204596 A1
(43) Pub. Date: Aug. 28, 2008

(54) DISPLAY APPARATUS AND DISPLAY METHOD THEREOF

(75) Inventor: Kwang-hyun Koh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/873,651

(22) Filed: Oct. 17, 2007

Related U.S. Application Data
(60) Provisional application No. 60/902,875, filed on Feb. 23, 2007.

(30) Foreign Application Priority Data
Mar. 15, 2007 (KR) 10-2007-0025739

(51) Int. Cl. H04N 5/44; G09G 5/00; H04N 5/68

(52) U.S. Cl. 348/563; 345/214; 348/607; 715/700; 348/E05.021; 348/E05.1; 348/E13.005

(57) ABSTRACT

A display apparatus includes: an image processing unit that processes a main image corresponding to an image signal received from an external source and an auxiliary image generated by execution of an application; a display unit that displays the main and auxiliary images processed by the image processing unit; and a controller that controls the image processing unit not to display the auxiliary image if the auxiliary image is displayed on the display unit for more than a reference time period.

### CROSS-REFERENCE TO RELATED APPLICATIONS

This application claims priority from Korean Patent Application No. 10-2007-0025739, filed on Mar. 15, 2007 in the Korean Intellectual Property Office, and U.S. Provisional Patent Application No. 60/902,875, filed on Feb. 23, 2007, the disclosures of which are incorporated herein by reference in their entirety.

### BACKGROUND OF THE INVENTION

1. Field of Invention

Apparatuses and methods consistent with the present invention relate to a display apparatus and a display method thereof, and more particularly, to a display apparatus and a display method thereof, which are capable of removing an afterimage which may occur when an auxiliary image generated by execution of an application is displayed.

2. Description of the Related Art

A display apparatus displays an image based on an image signal. The display apparatus represents a moving picture by continuously displaying a series of image such as a frame. An image displayed on the display apparatus may have little change for more than a predetermined time period. In this case, pixels of a display unit included in the display apparatus may be deteriorated, which may cause an afterimage, and particular pixels may become have a shorter lifetime than other adjacent pixels.

Various related art methods of removing an afterimage have been proposed. For example, if an image does not change for more than a predetermined time period, the afterimage may be removed by not displaying or moving little by little vertically and horizontally all or some of the image, or replacing all or some of the image with a different image.

However, a region on which the image does not change is displayed has to be detected in order to use such related art methods, which requires a complicated image processing algorithm.

### SUMMARY OF THE INVENTION

The present invention provides a display apparatus and a display method thereof, which are capable of removing an afterimage which may occur due to an auxiliary image generated by execution of an application, without using a complicated image processing algorithm.

According to an aspect of the present invention, there is provided a display apparatus including: an image processing unit that processes a main image corresponding to an image signal received from the outside and an auxiliary image generated by execution of an application; a display unit that displays the main and auxiliary images processed by the image processing unit; and a controller that controls the image processing unit not to display the auxiliary image if the auxiliary image is displayed on the display unit for more than a reference time period.

The application may include an application for data broadcasting.

The application may be included in a broadcasting signal.

The display apparatus may further include a storing unit that stores the application.

The controller may include: a graphic plane managing unit that controls display of a graphic plane on which the auxiliary image is displayed; a screen managing unit that controls display of a screen which is included in the graphic plane and includes at least one of a plurality of applications; and an application managing unit that controls display of the applications.

The application managing unit may control the image processing unit not to display the auxiliary image if the auxiliary image corresponding to one of the plurality of applications is displayed for more than the reference time period.

The graphic plane managing unit controls the image processing unit not to display the entire auxiliary image if the auxiliary image corresponding to at least one of the plurality of applications is displayed for more than the reference time period.

The screen managing unit may control the image processing unit not to display the screen including the auxiliary image if the auxiliary image corresponding to at least one of the plurality of applications is displayed for more than the reference time period.

The controller may suspend or terminate execution of the application so that the auxiliary image is not displayed.

The controller may display the auxiliary image on the display unit if a predetermined time period elapses after the auxiliary image has not been displayed according to lapse of more than the reference time period.

The display apparatus may further include a user input unit, wherein the controller displays the auxiliary image on the display unit if there is an input through the user input unit in a condition where the auxiliary image is not being displayed.

The display apparatus may further include a user input unit, wherein the controller measures the reference time period from a point of time when there is an input through the user input unit while the auxiliary image is being displayed.

The display apparatus may further include a user interface (UI) generating unit that generates a user interface for display of the auxiliary image under control of the controller.

According to another aspect of the present invention, there is provided a display method of a display apparatus including a display unit, the display method including: displaying a main image corresponding to an image signal received from the outside and an auxiliary image generated by execution of an application on the display unit; determining whether the auxiliary image is displayed on the display unit for more than a reference time period; and terminating the displaying of the auxiliary image if the auxiliary image is displayed for more than the reference time period.

The application may include an application for data broadcasting.

The application may be included in a broadcasting signal.

The terminating may include terminating the displaying of the auxiliary image if the auxiliary image corresponding to one of a plurality of applications is displayed for more than the reference time period.

The terminating may include terminating the displaying of the entire auxiliary image if the auxiliary image corresponding to at least one of a plurality of applications is displayed for more than the reference time period.

The terminating may include suspending or terminating execution of the application so that the auxiliary image is not displayed.

The method may include displaying the auxiliary image on the display unit if a predetermined time period elapses after the auxiliary image has not been displayed according to lapse of more than the reference time period.

The display method may further include displaying the auxiliary image on the display unit if there is an input from a user in a condition where the auxiliary image is not being displayed.

The displaying the main image and the auxiliary image may include measuring the reference time period from a point of time when there is an input from a user while the auxiliary image is being displayed.

The terminating may include generating a user interface for display of the auxiliary image and displaying the generated user interface on the display unit.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram showing a configuration of a display apparatus according to a first exemplary embodiment of the present invention;

FIG. 2 is a view showing an example in which the display apparatus according to the first exemplary embodiment does not display an auxiliary image;

FIG. 3A is a block diagram showing a configuration of a display apparatus according to a second exemplary embodiment of the present invention;

FIG. 3B is a block diagram showing a configuration of a controller according to an exemplary embodiment of the present invention;

FIG. 3C is a view illustrating a display method of an application of the display apparatus according to an exemplary embodiment of the present invention;

FIG. 4 is a view showing a user interface of the display apparatus according to an exemplary embodiment of the present invention; and

FIG. 5 is a flow chart illustrating a display method of the display apparatus according to an exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

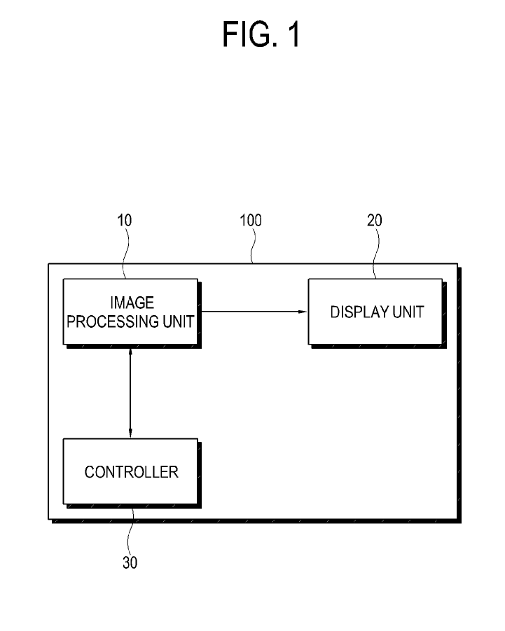

As shown in FIG. 1, a display apparatus 100 according to a first exemplary embodiment of the present invention includes an image processing unit 10, a display unit 20 and a controller 30. The display apparatus 100 may be embodied as a digital television (TV) or other known display apparatuses in the art.

The image processing unit 10 processes a main image corresponding to an image signal received from an external source, and an auxiliary image generated by execution of an application with respect to the main image. In addition, the image processing unit 10 may perform decoding for extracting image information from the received image signal, scaling for adjusting resolution of the decoded image depending on characteristics of the display unit 20 and user's settings, and picture enhancement for enhancing image quality.

The image signal received from the external source may include not only an image signal received from a broadcasting station but also an image signal received from an external image source via an interface such as Digital Video Interface (DVI) or S-Video.

In addition, the image processing unit 10 may perform image processing including receiving a user interface (UI) image, generating an image including the received UI image, and display the generated image on the display unit 20 under control of the controller 30.

The display unit 20 displays the main and auxiliary images processed by the image processing unit 10. The display unit 20 may be embodied as a cathode ray tube (CRT), a plasma display panel (PDP), a liquid crystal display (LCD), a digital light processing (DLP) display, a surface-conduction electron-emitter display (SED), a field emission display (FED) or other display devices known in the art.

In the PDP, if a still image is displayed for a long time period, fluorescent substance applied on separators of cells is worn away, which may result in many afterimages occurring between bright and dark portions. In the LCD, since the LCD does not provide a fast response to an image signal, if a still image is displayed for a long time period and then a different image is displayed for a long time period, many afterimages may occur. For this reason, in exemplary embodiments of the present invention, the display unit 20 may be embodied as the PDP or the LCD.

If the auxiliary image is displayed on the display unit 20 for more than a reference time period, the controller 30 controls the image processing unit 10 not to display the auxiliary image.

In this exemplary embodiment, the auxiliary image may include not only an image displayed by execution of an application but also an image used to perform an additional function such as on screen display (OSD) or UI. Specifically, the auxiliary image may include not only a sub image of the main image but also a menu, a caption, an electronic program guide (EPG) and the like, which are independent of the main image. The application corresponding to the auxiliary image may be received by being included in a broadcasting signal or the received application may be pre-stored in a storing unit (not shown). Hereinafter, the auxiliary image will be exemplarily illustrated with an image displayed by execution of the application.

With support of a ‘Hide’ function to prevent the application from being displayed on the display unit 20, the controller 30 may call a function (for example, Hide( )) to release display of the application among Application Program Interfaces (APIs) in order to release display of the auxiliary image by execution of the application. If the auxiliary image is not displayed on the display unit 20, the controller 30 may call a function (for example, Show( )) to display the application after a predetermined time period elapses in order to display the auxiliary image again.

If the controller 30 has information on a position at which the application is displayed, a process of determining a region in hiding the auxiliary image displayed by execution of the application may be omitted.

In addition, upon receiving an image signal from the outside, the controller 30 may receive information on the application through Program and System Information Protocol (PSIP) included in the received image signal. Specifically, the controller 30 receives Program Map Table (PMT) data included in the image signal and checks whether Application Information Table (AIT) data exists based on a service type information value corresponding to channel list information included in the PMT data.

In this exemplary embodiment, if the service type information value is 0x05, the controller 30 determines that the AIT data exist and determines whether display of the still image is released depending on an application attribute included in the AIT data. For example, if the application attribute included in the AIT data does not support the Hide function of the application and if the still image corresponding to the application is displayed for more than a reference time period, the controller 30 may control a region for the still image not to be displayed on the display unit 20.

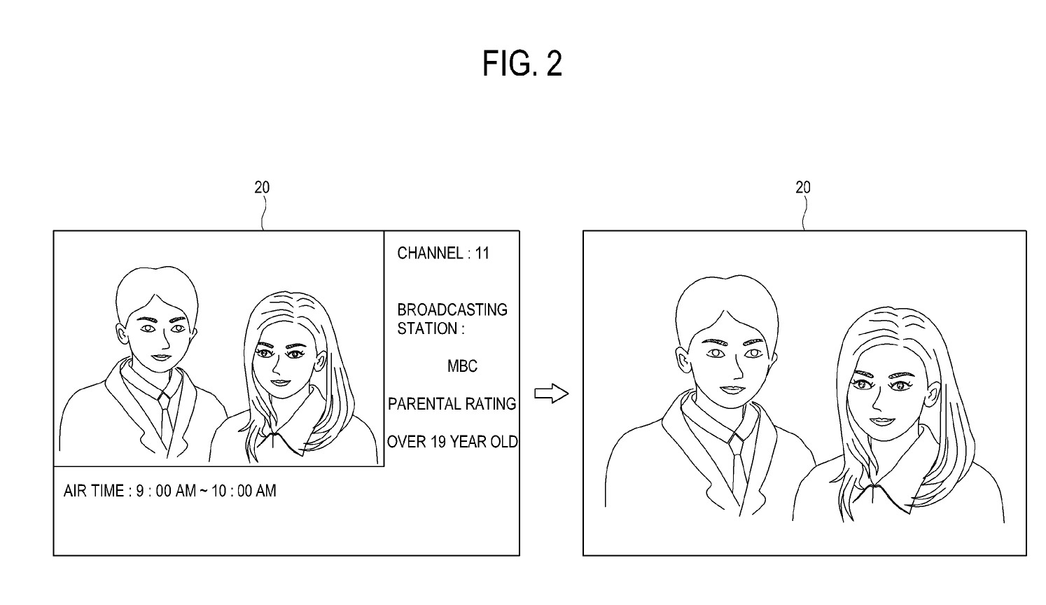

On the other hand, the controller 30 may control the image processing unit 10 not to display all of the still image corresponding to the application displayed on the display unit 20. In this case, if the size of an image corresponding to a received image signal has become small due to the display of the application, the controller 30 may adjust the size of the image corresponding to the image signal to the entire size of the display unit 20, as shown in FIG. 2.

Also, in addition to not displaying the auxiliary image displayed by the execution of the application, the controller 30 may terminate the execution of the application to remove an afterimage which may be displayed on the display unit 20. In this case, if the execution of the application is terminated, the controller 30 may execute the application again after a predetermined time period elapses.

In addition, if a plurality of applications is executed, the controller 30 may control the image processing unit 10 not to display auxiliary images, which are to be displayed by execution of the applications, independently. Also, if at least one of the plurality of applications is displayed on the display unit 20 for more than a reference time period, the controller 30 may control the image processing unit 10 not to display all of the auxiliary images corresponding to the plurality of applications.

On the other hand, the controller 30 may measure a time for which the auxiliary image is displayed, and, if there is an input from a user, may initialize the time for which the auxiliary image is displayed in order to measure the reference time period again. Here, the controller 30 may measure the reference time period at the same time of displaying the auxiliary image not only if there is the input from the user under a condition where the auxiliary image is displayed but also if there is the input from the user under a condition where the auxiliary image is not displayed.

If a plurality of applications is executed, the controller 30 may measure the reference time period for each of the applications independently while the applications are displayed on the display unit 20. The reference time period may be determined from the time when the application is displayed on the display unit 20.

In addition, if the auxiliary image is not displayed on the display unit 20 as a result of more than the reference time period elapsing, the controller 30 may control the image processing unit 10 to display the auxiliary image on the display unit 20 again after a predetermined time period elapses.

In addition, if the auxiliary image is displayed for more than the reference time period, the controller 30 may cause the auxiliary image to be displayed at a position different from the position at which the auxiliary image has been displayed.

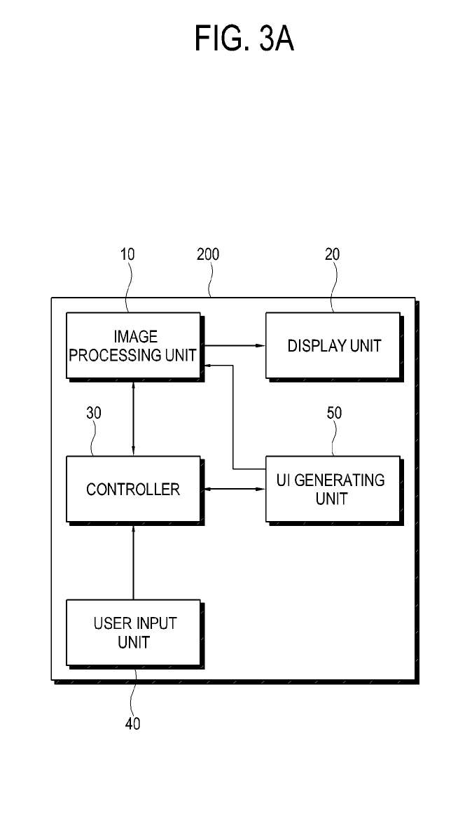

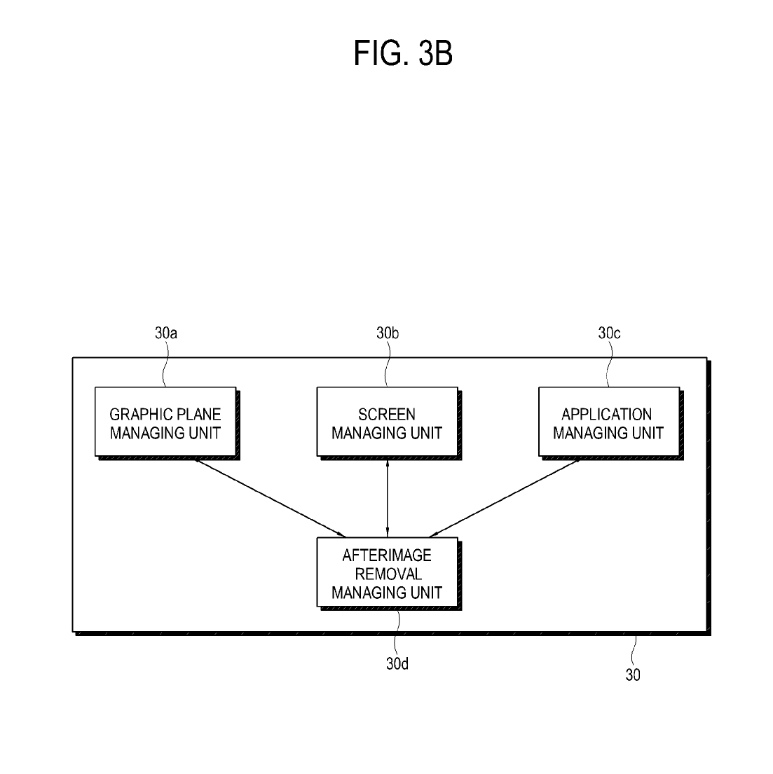

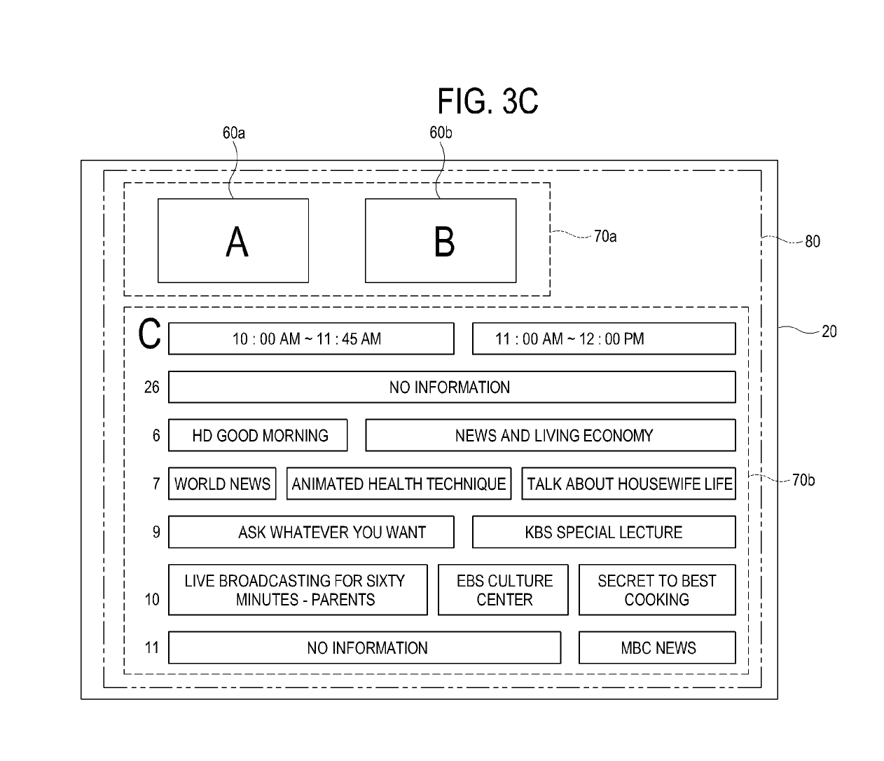

Hereinafter, a display apparatus 200 according to a second exemplary embodiment of the present invention will be described with reference to FIG. 3A.

As shown in FIG. 3A, the display apparatus 200 further includes a user input unit 40 and a UI generating unit 50 in addition to the elements of the display apparatus 100 according to the first exemplary embodiment. In the following description, the same elements as in the display apparatus 100 are denoted by the same reference numerals, and explanation of which will be omitted for the sake of simplification of description.

The user input unit 40 receives an instruction to display the auxiliary image from a user. In addition, the user input unit 40 may receive other instructions related to operation of the display apparatus 200 from the user. In this exemplary embodiment, the user input unit 40 may be embodied as a remote controller including menu keys and a key signal generating unit that generates a key signal when a key is pushed. Of course, the user input unit 40 may be provided at one side of a main body of the display apparatus 200.

If there is an input through the user input unit 40 in a condition where the auxiliary image by execution of the application is not displayed on the display unit 20, the controller 30 may cause the auxiliary image to be displayed on the display unit 20 again. In this case, the user input unit 40 may include a separate key for display of the application. In addition, if there is an input from the user after the reference time period elapses, the controller 30 may cause an image different from the auxiliary image to be displayed on the display unit 20.

In addition, if a UI for input of an instruction to display the auxiliary image by execution of the application is displayed on the display unit 20, the user input unit 40 may determine whether to display the auxiliary image.

If there is an input from the user input unit 40 in a condition where the auxiliary image is not displayed, the controller 30 may cause the auxiliary image to continue not to be displayed in spite of the input from the user input unit 40. In addition, the controller 30 may control the application corresponding to the auxiliary image not to be focused on, in a condition where the auxiliary image is not displayed on the display unit 20.

On the other hand, as shown in FIG. 3B, the controller 30 may include a graphic plane managing unit 30a that controls display of a graphic plane on which the auxiliary image is displayed, a screen managing unit 30b that controls display of a screen which is included in the graphic plane and includes at least one application, an application managing unit 30c that controls display of the application, and an afterimage removal managing unit 30d that controls the image processing unit 10 not to display the auxiliary image if the auxiliary image is displayed on the display unit 20 for more than the reference time period.

Here, the graphic plane means an entire graphic region on which the auxiliary image except an image signal is displayed, and the screen means a region which includes at least one application and is included in the graphic plane.

FIG. 3C is a view showing a relationship between a graphic plane, screens and applications in the display apparatus 200 according to an exemplary embodiment of the present invention. As shown in FIG. 3C, an application A 60a and an application B 60b are included in a screen 70a, and an application C 60c is included in a screen 70b. The screen 70a and the screen 70b are included in a graphic plane 80.

The application managing unit 30c included in the controller 30 may control each of the applications not to be displayed on the display unit 20, and the screen managing unit 30b may control the application not to be displayed on the display unit 20 in a unit of screen. That is, if the screen managing unit 30b controls the screen 70a not to be displayed, the application A 60a and the application B 60b are not displayed on the display unit 20. In addition, if the graphic plane managing unit 30a controls the graphic plane not to be displayed, every application is not displayed on the display unit 20.

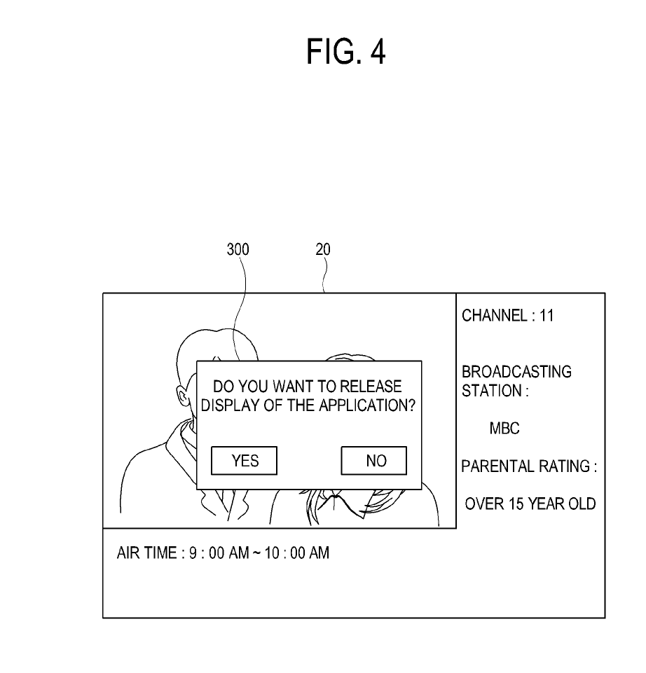

The UI generating unit 50 generates a UI for inputting of an instruction to display the auxiliary image by execution of the application. FIG. 4 is a view showing a UI 300 generated by the UI generating unit 50 of the display apparatus 200 according to an exemplary embodiment of the present invention. As shown in FIG. 4, if the controller 30 causes the auxiliary image provided by execution of the application not to be displayed on the display unit 20 after more than the reference time period elapsing, the controller 30 may control the UI generating unit 50 to generate the UI 300 to inform a user of this matter. In this case, the controller 30 may adjust transparency of the UI 300 to be greater than a reference value in order to prevent an afterimage from being displayed on the display unit 20.

On the other hand, the UI generated by the UI generating unit 50 may perform an additional function for displaying an image as well as the function to input the instruction to display the auxiliary image. In this case, the controller 30 may control the image processing unit 10 not to display not only the application included in the image signal received from the outside but also the UI generated by the UI generating unit 50 if the UI is displayed as a still image on the display unit 20 for more than the reference time period.

Of course, if the UI generated by the UI generating unit 50 is displayed as the still image on the display unit 20 for more than the reference time period, the controller 30 may control the UI generating unit 50 to periodically change the UI itself displayed on the display unit or change a position at which the UI is displayed on the display unit 20.

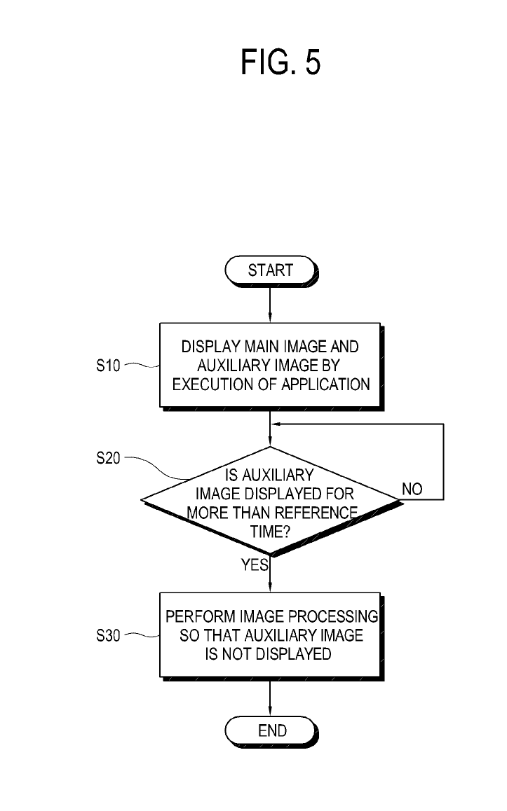

Hereinafter, a display method of the display apparatus 100 and 200 according to the exemplary embodiments of the present invention will be described with reference to FIG. 5.

First, the controller 30 displays a main image corresponding to an image signal inputted from the outside and an auxiliary image generated by execution of an application on the display unit 20 at operation S10.

In this exemplary embodiment, the operation S10 may include an operation of measuring a reference time period again if there is an input through the user input unit 40 before the reference time period elapses.

Next, the controller 30 determines whether the auxiliary image is displayed on the display unit 20 for more than the reference time period at operation S20. Even if the auxiliary image is displayed on the display unit 10 at the operation S10, the controller 30 may measure the reference time period from a point of time when there is the input through the user input unit 40.

Next, if it is determined that the auxiliary image is displayed for more than the reference time period, the controller 30 controls the image processing unit 10 not to display the auxiliary image on the display unit at operation S30.

In the operation S30, if there exists a plurality of applications as an example of the auxiliary image, the controller 30 may control the image processing unit 10 not to display all of a plurality of auxiliary images on the display unit 20 if one of the plurality of auxiliary images by execution of the plurality of applications is displayed on the display unit 10 for more than the reference time period.

As apparent from the above description, the exemplary embodiments of the present invention provide a display apparatus and a display method thereof, which are capable of removing an afterimage which may occur due to an auxiliary image generated by execution of an application, without using a complicated image processing algorithm.

In addition, the exemplary embodiments of the present invention provide a display apparatus and a display method thereof, which are capable of removing an afterimage either when an application is received from the outside or when an application is stored in the display apparatus.

Furthermore, the exemplary embodiments of the present invention provide a display apparatus and a display method thereof, which are capable of preventing an afterimage from being generated due to a plurality of auxiliary images by execution of a plurality of applications by causing the auxiliary images not to be displayed independently or entirely.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
an image processing unit that processes a main image corresponding to an image signal received from an external source and an auxiliary image generated by execution of an application;
a display unit that displays the main and auxiliary images processed by the image processing unit; and
a controller that controls the image processing unit not to display the auxiliary image if the auxiliary image is displayed on the display unit for more than a reference time period.

2. The display apparatus according to claim 1, wherein the application comprises an application for data broadcasting.

3. The display apparatus according to claim 2, wherein the application is included in a broadcasting signal.

4. The display apparatus according to claim 3, the application pre-stored in the display apparatus.

5. The display apparatus according to claim 1, wherein the controller comprises:
a graphic plane managing unit that controls display of a graphic plane on which the auxiliary image is displayed;
a screen managing unit that controls display of a screen which is included in the graphic plane and comprises at least one of a plurality of applications; and
an application managing unit that controls display of the applications.

6. The display apparatus according to claim 5, wherein the application managing unit controls the image processing unit not to display the auxiliary image if the auxiliary image corresponding to one of the plurality of applications is displayed for more than the reference time period.

7. The display apparatus according to claim 5, wherein the graphic plane managing unit controls the image processing unit not to display the entire auxiliary image if the auxiliary image corresponding to at least one of the plurality of applications is displayed for more than the reference time period.

8. The display apparatus according to claim 5, wherein the screen managing unit controls the image processing unit not to display the screen including the auxiliary image if the auxiliary image corresponding to at least one of the plurality of applications is displayed for more than the reference time period.

9. The display apparatus according to claim 1, wherein the controller suspends or terminates execution of the application so that the auxiliary image is not displayed.

10. The display apparatus according to claim 1, wherein the controller displays the auxiliary image on the display unit if a predetermined time period elapses after the auxiliary image has not been displayed due to more than the reference time period elapsing.

11. The display apparatus according to claim 1, further comprising a user input unit,
wherein the controller displays the auxiliary image on the display unit if an input is received through the user input unit in a condition in which the auxiliary image is not being displayed.

12. The display apparatus according to claim 1, further comprising a user input unit,
wherein the controller measures the reference time period from a point of time when an input is received through the user input unit while the auxiliary image is being displayed.

13. The display apparatus according to claim 10, further comprising a user interface (UI) generating unit that generates a user interface for displaying of the auxiliary image under control of the controller.

14. A display method of a display apparatus including a display unit, the display method comprising:
displaying on the display unit a main image corresponding to an image signal received from an external source and an auxiliary image generated by execution of an application;
determining whether the auxiliary image is displayed on the display unit for more than a reference time period; and
terminating the displaying of the auxiliary image if it is determined that the auxiliary image is displayed for more than the reference time period.

15. The display method according to claim 14, wherein the application comprises an application for data broadcasting.

16. The display method according to claim 15, wherein the application is included in a broadcasting signal.

17. The display method according to claim 14, wherein the terminating of the displaying of the auxiliary image comprises terminating the displaying of the auxiliary image if it is determined that the auxiliary image corresponding to one of a plurality of applications is displayed for more than the reference time period.

18. The display method according to claim 14, wherein the terminating of the displaying of the auxiliary image comprises terminating of the displaying the entire auxiliary image is not displayed if the auxiliary image corresponding to at least one of a plurality of applications is displayed for more than the reference time period.

19. The display method according to claim 14, wherein the terminating of the displaying of the auxiliary image comprises suspending or terminating execution of the application so that the auxiliary image is not displayed.

20. The display method according to claim 14, further comprising displaying again the auxiliary image on the display unit if a predetermined time period elapses after the auxiliary image has not been displayed due to more than the reference time elapsing.

21. The display method according to claim 14, further comprising displaying again the auxiliary image on the display unit if an input is received from a user in a condition in which the auxiliary image is not being displayed.

22. The display method according to claim 14, wherein the displaying the main image and the auxiliary image comprises measuring the reference time period from a point of time when an input is received from a user while the auxiliary image is being displayed.

23. The display method according to claim 20, wherein the terminating of the displaying of the auxiliary image comprises generating a user interface for displaying the auxiliary image and displaying the user interface on the display unit.
